(19) United States
(12) Patent Application Publication
(10) Pub. No.: US 2020/0183742 A1
(43) Pub. Date: Jun. 11, 2020

(54) METHOD OF MANAGING ELECTRICITY PROVIDING IN A COMPUTERS CLUSTER

(71) Applicant: BULL SAS, Les Clayes Sous Bois (FR)

(72) Inventors: Yiannis GEORGIOU, Lyon (FR); David GLESSER, Uriage (FR); Andry RAZAFINJATOVO, Renage (FR)

(21) Appl. No.: 16/310,110

(22) PCT Filed: Jun. 16, 2016
(86) PCT No.: PCT/IB2016/001047

§ 371 Date: Dec. 14, 2018

(51) Int. Cl. G06F 9/48; G06F 9/38; G06F 1/3206; G06Q 30/02; G06Q 10/06; G06Q 10/04

(52) U.S. Cl. CPC G06F 9/4893; G06F 9/3891; G06Q 10/04; G06Q 30/0206; G06Q 10/06315; G06F 1/3206

(57) ABSTRACT

Disclosed is a method of managing electricity providing in a computers cluster, including: a process of prediction of electricity price provided by at least one electricity source, a process of prediction of workload in the computers cluster, a process of scheduling tasks in the computers cluster, based on both the prediction processes.

### FIELD OF THE INVENTION

The invention relates to a method of managing electricity providing in a computers cluster, as well as a method of operating a computers cluster including a method of managing electricity providing in a computers cluster and a method of scheduling tasks in this computers cluster.

### BACKGROUND OF THE INVENTION

According to a prior art, when managing a computers cluster, since this cluster comprises so many computers, sometimes at least several hundred computers, or even at least several thousand computers, to optimize the scheduling of the numerous tasks to be performed within the cluster is quite difficult.

Indeed, taking into account many parameters, like the number of tasks to be performed, the computing resources required by these tasks, the deadlines associated to these tasks, and when appropriate, all these parameters varying over time, makes scheduling tasks in a computers cluster rather difficult.

A computers cluster needs at least one energy source to perform the required tasks, this energy source being electricity. When scheduling tasks, the managing system has to take into account, the availability of electricity to supply power to the computers cluster. This usually includes for example the maximum available electrical power and unavailability time slots for repair and maintenance.

But, since the scheduling process is already rather complicated, the supplementary parameter of electricity price is not taken into account. This supplementary parameter of electricity price is considered as disturbing the efficiency of the scheduling process and therefore not used.

Indeed, an algorithm that schedules tasks in a high performance computers cluster is hard to make because the scheduling decisions have to be done quickly according to multiple constraints and should control a possible large number of computing resources.

Then, taking into account electricity price variation is even more difficult because it add some constraints to the already complex scheduling algorithm.

However, according to the invention, in a cluster including a large number of computers, it becomes interesting to manage the cluster operation according to the varying price of electricity providing over time. Besides, disturbance of scheduling is not that high when including as parameter the varying price of electricity providing. Moreover, when managing this supplementary parameter the right way, such disturbance can be substantially lowered and even cancelled, while cost savings, because of inclusion of this supplementary parameter, become substantial in a cluster comprising a big number of computers.

### SUMMARY OF THE INVENTION

The object of the present invention is to alleviate at least partly the above mentioned drawbacks.

More particularly, the invention aims to take into account the electricity price variations over time, when scheduling tasks in a computers cluster, and especially in a cluster including many computers.

This object is achieved with a method of managing electricity providing in a computers cluster, comprising: a process of prediction of electricity price provided by at least one electricity source, a process of prediction of workload in said computers cluster, a process of scheduling tasks in said computers cluster, based on both said prediction processes.

According to preferred embodiments of the invention, an electricity cost aware workload scheduling is performed, preferably with multiple energy sources. Workload scheduling is then performed in high performance computing clusters by taking into account the electricity price in a context where the utilized energy presents a varying price over time.

To take into account electricity price in a more efficient manner, what means with a reduced disturbance in tasks scheduling process, this more precise object is achieved by adding supplementary technical features which allow the electricity prediction process to improve over time until it becomes very efficient and causes a limited disturbance as compared with a tasks scheduling process which would not be cost aware.

This more precise object is achieved with a managing method, wherein said process of prediction of electricity price receives a feedback from said process of scheduling tasks, said process of prediction of electricity price improves, based on said feedback.

To take into account electricity price in an even more efficient manner, what means with a very reduced disturbance in tasks scheduling process, this even more precise object is achieved by adding other supplementary technical features which allow the electricity prediction process to improve over time until it becomes fully efficient and causes a very limited disturbance as compared with a tasks scheduling process which would not be cost aware. Indeed, the feedback being based on scheduling performances rather than on price prediction precision, the disturbance effect on scheduling performances will be quickly limited over time. According to embodiments of the invention, it has been discovered that basing the feedback on scheduling performances rather than on price prediction precision (as it would seem more natural), is astonishingly globally more efficient, and more quickly efficient during the learning progress of the electricity price prediction process.

This even more precise object is achieved with a managing method, wherein said feedback, to said process of prediction of electricity price, is based on an evaluation of scheduling performances in said computers cluster more than on an evaluation, if any, of electricity price prediction precision.

To continue to improve the efficiency of the learning progress of the electricity price prediction process, this feedback is done through a cost function.

Preferably, said feedback, to said process of prediction of electricity price, updates a cost function of said process of prediction of electricity price which is based on an evaluation of scheduling performances in said computers cluster more than on an evaluation, if any, of electricity price prediction precision.

To still continue to improve the efficiency of the learning progress of the electricity price prediction process, this feedback is exclusively based on scheduling performances and not at all on price prediction precision.

Preferably, said feedback, to said process of prediction of electricity price, is based on an evaluation of scheduling performances in said computers cluster, and not on an evaluation of electricity price prediction precision.

According to embodiments of the invention, the proposed solution performs electricity price prediction, advantageously on multiple different electricity sources, as well as computing demand prediction and tasks scheduling, and all that at the same time.

Preferred embodiments comprise one or more of the following features, which can be taken separately or together, either in partial combination or in full combination.

Preferably, said process of prediction of electricity price provides the electricity prices provided by at least two different electricity sources.

The managing method according to the invention is all the more interesting as the electricity price becomes more and more variable, what is the case when electricity can be supplied from different electrical sources with different varying prices over time. It is in this more complicated case too that the cost savings, by taking into account the electricity price variations over time, may become the highest. Indeed, electricity prices provided by the different electricity sources are prices which vary over time, and which vary most often rather differently between these electricity sources.

Preferably, said process of scheduling tasks will spread electricity needs of said computers cluster between said different electricity sources by promoting the cheapest of said different electricity sources.

Thereby, more costs will be saved, while high electricity supply power will be maintained, and therefore good scheduling performances will be kept. The cheapest of electricity may vary over time, and the promoted electricity source(s) will change over time.

Preferably, said different electricity sources include at least one renewable electricity source and/or at least one stored electricity source and/or at least a grid.

A renewable energy source can be for example one or more wind turbines, one or more solar panels, one or more hydraulic retentions. A stored electricity source can be for example a super capacitor or a battery, for example a Lithium-Ion battery.

Preferably, said electricity price prediction process uses weather forecasting to predict electricity price provided by a renewable electricity source.

Workload scheduling is performed in high performance computing clusters by taking into account the electricity price in a context where the utilized energy is generated from different electricity sources with varying prices over time. In the typical use case electricity will be generated simultaneously from renewable technologies, from electricity storage equipment, and from the grid. The electricity price at each moment will be calculated based on the percentage of each energy usage. In such a case, the managing method will be advantageously based upon combination of machine learning, weather forecasting and real time sensors monitoring analytics for accurate electricity price prediction along with their adaptation on the workload demands.

Predicting electricity price will be different from an electricity source to another electricity source. Indeed, depending on the source, the cost of electricity should be computed differently. For example, solar panel electricity price is highly correlated with the hour of the day and the weather, whereas grid electricity price depends on a specific market which uses data coming from electricity stock exchanges. These prediction steps are coupled with the corresponding electricity sources and may be integrated within the more global electricity prediction process.

Preferably, said process of prediction of workload receives a feedback from said process of scheduling tasks, said process of prediction of workload improves, based on said feedback.

Here again, the feedback from scheduling process to workload prediction process improves the quality of workload prediction process over time and its contribution to computers cluster operation improvement.

Preferably, said feedback, to said process of prediction of workload, is based on an evaluation of scheduling performances in said computers cluster more than on an evaluation, if any, of workload prediction precision. Here again, the feedback from scheduling process to workload prediction process, based on scheduling performances rather than on workload prediction precision, improves the quality of workload prediction process over time more rapidly and more efficiently as well as its contribution to scheduling performances improvement.

To continue to improve the efficiency of the learning progress of the workload prediction process, this feedback is done through a cost function.

Preferably, said feedback, to said process of prediction of workload, updates a cost function of said process of prediction of workload which is based on an evaluation of scheduling performances in said computers cluster more than on an evaluation, if any, of workload prediction precision.

To still continue and improve the efficiency of the learning progress of the electricity price prediction process, this feedback is exclusively based on scheduling performances and not at all on price prediction precision.

While the electricity price evolves in time, the computing resource demands also evolve in time. Not only the number of tasks but also their characteristics, as for example computing resources needed, preferred or final deadlines, will change over time. Including the prediction of these different aspects in the managing method according to embodiments of the invention will improve performance of the whole system.

Preferably, said feedback, to said process of prediction of workload, is based on an evaluation of scheduling performances in said computers cluster, and not on an evaluation of workload prediction precision.

Preferably, the managing method further comprises sensing an actual workload in said computers cluster, and wherein said process of scheduling tasks in said computers cluster is also based on said sensed actual workload.

The actual workload is a useful parameter, first to help tasks scheduling process, and second to check practically in real time workload prediction precision, if needed.

Preferably, said actual workload evolves over time, not only the number of tasks to be computed evolves over time, but also the computed resources required by said tasks and the deadlines of said tasks evolve over time.

Thereby, this parameter of actual workload is quite representative of the complexity of the computing cluster to manage.

Preferably, the managing method further comprises sensing one or more actual electricity price(s), and wherein said process of scheduling tasks in said computers cluster is also based on said sensed actual electricity price(s).

The actual electricity price is a useful parameter, first to help tasks scheduling process, and second to check practically in real time electricity price prediction precision, if needed.

Preferably, according to an embodiment of the invention, at least one of said prediction processes, preferably both said prediction processes, are based on using support vector machines.

Preferably, according to an alternative embodiment of the invention, at least one of said prediction processes, preferably both said prediction processes, are based either on using a supervised learning algorithm, preferably a nearest neighbor algorithm or a random forest algorithm, or on using a deep learning algorithm.

Preferably, according to an embodiment of the invention, said process of scheduling tasks is based on using a greedy algorithm, preferably a Backfilling algorithm.

Preferably, according to an alternative embodiment of the invention, said process of scheduling tasks is based on using an integer programming algorithm.

Preferably, said process of scheduling tasks takes into account a constraint of overall electrical power limit.

Thereby the managing method according to embodiments of the invention is even more secure, since it will not perform optimized tasks scheduling impossible to achieve due to unavailability of a sufficient amount of electricity at a given time.

Preferably, said process of scheduling tasks takes into account an objective of reducing the platforms overall electricity cost while, at the same time, maintaining high computers cluster utilization.

Thereby, a better compromise may be found between on the one hand the global cost of the electricity used by the platforms providing electricity to the computers cluster and on the other hand the computing cluster use rate. As a result, the computers cluster is still thoroughly used, but significant cost savings are realized with respect to electricity provided to this computers cluster.

Further features and advantages of the invention will appear from the following description of embodiments of the invention, given as non-limiting examples, with reference to the accompanying drawings listed hereunder.

### BRIEF DESCRIPTION OF THE DRAWINGS

FIG. 1 shows an example of a system showing the processes used by the managing method according to an embodiment of the invention, and the progress of their interaction.

### DETAILED DESCRIPTION OF THE INVENTION

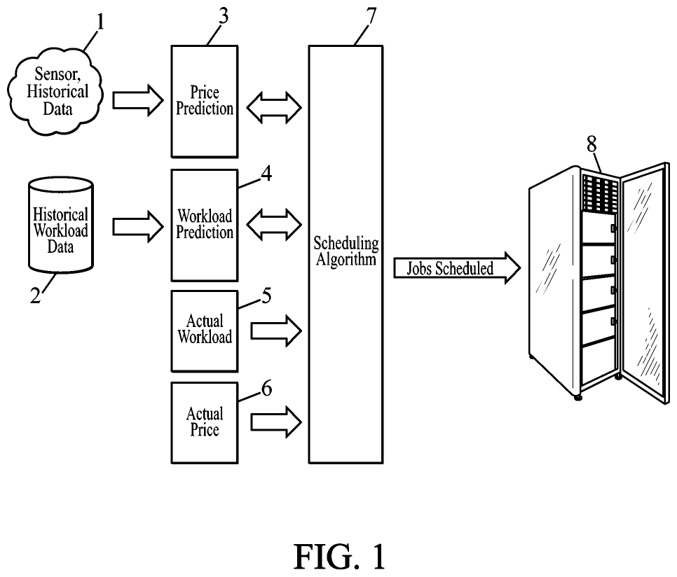

FIG. 1 shows an example of a system showing the processes used by the managing method according to an embodiment of the invention, and the progress of their interaction.

The managing method according to embodiments of the invention uses two data libraries 1 and 2, the data library 1 for the electricity price prediction process 3, and the data library 2 for the workload prediction process 4. Data library 1 may include sensor data and historical data. Data library 2 may include only historical data. The tasks scheduling process 7 uses the electricity price prediction made by the electricity price prediction process 3 and the workload prediction made by the workload prediction process 4, as well as an actual workload got from actual workload sensing 5, and one or more electricity prices coming respectively from one or more different electricity sources got from actual electricity price sensing 6.

The tasks scheduling process 7 gives a feedback both to the electricity price prediction process 3 and to the workload prediction process 4, both feedbacks being based rather on scheduling performances than on prediction precisions. Scheduling performances may include, for example, the percentage of required tasks which has been performed, as well as the delays (or periods in advance, if appropriate) with which those tasks have been performed, and the completeness with which these tasks have been performed.

The tasks scheduling process 7 schedules tasks within the computers cluster 8 and measures or determines the scheduling performances of a batch of tasks which have been performed within a given time frame.

There are two prediction processes (or algorithms) 3 and 4 and a scheduling process (or algorithm) 7. The prediction processes 3 and 4 predict the electricity price and the computing resource needs. These prediction processes 3 and 4 communicate bi-directionally with the scheduling process 7.

The scheduling process 7 takes into account both prediction processes 3 and 4, as well as the actual state of the system to make scheduling decisions.

The communication between all these processes is an important point to the good progress of the managing method according to embodiments of the invention. The prediction processes 3 and 4 not only tell the prediction but also receive from the scheduling process 7 how helpful these predictions have been for the scheduling performances and in order to improve these scheduling performances.

The prediction processes 3 and 4 can be support vector machines where the input is historical values of electricity price for each of the electricity sources and historical computing needs. This kind of prediction process 3 or 4 learns from historical values by assigning new inputs into one category or the other. The number of categories can be very large making these prediction processes 3 and 4 able to predict real numbers with a good precision.

The cost function of these prediction processes 3 and 4 is based on the evaluation of the scheduling performances, instead of being based on the precision of their predictions.

As an alternative, the prediction processes 3 and 4 may use supervised learning algorithm, like nearest neighbor algorithm or random forest algorithm. Deep learning algorithms can also be used instead.

The scheduling process 7 can be a modified version of the backfilling algorithm. This family of greedy algorithms is fast and powerful enough to fulfill the requirements of the managing method according to embodiments of the invention.

As an alternative, the scheduling process 7 may use in some cases an integer programming algorithm, even if it is notably slower.

The invention has been described with reference to preferred embodiments. However, many variations are possible within the scope of the invention.

1. Method of managing electricity providing in a computers cluster (8), comprising:
a process of prediction of electricity price (3) provided by at least one electricity source,
a process of prediction of workload (4) in said computers cluster (8),
a process of scheduling tasks (7) in said computers cluster (8), based on both said prediction processes (3, 4).

2. Method of managing electricity providing in a computers cluster according to claim 1, wherein:
said process of prediction of electricity price (3) receives a feedback from said process of scheduling tasks (7),
said process of prediction of electricity price (3) improves, based on said feedback.

3. Method of managing electricity providing in a computers cluster, according to claim 2, wherein said feedback, to said process of prediction of electricity price (3), is based on an evaluation of scheduling performances in said computers cluster (8) more than on an evaluation, if any, of electricity price prediction precision.

4. Method of managing electricity providing in a computers cluster, according to claim 3, wherein said feedback, to said process of prediction of electricity price (3), updates a cost function of said process of prediction of electricity price (3) which is based on an evaluation of scheduling performances in said computers cluster (8) more than on an evaluation, if any, of electricity price prediction precision.

5. Method of managing electricity providing in a computers cluster, according to claim 3, wherein said feedback, to said process of prediction of electricity price (3), is based on an evaluation of scheduling performances in said computers cluster (8), and not on an evaluation of electricity price prediction precision.

6. Method of managing electricity providing in a computers cluster, according to claim 1, wherein said process of prediction of electricity price (3) provides the electricity prices provided by at least two different electricity sources.

7. Method of managing electricity providing in a computers cluster, according to claim 6, wherein said process of scheduling tasks (7) will spread electricity needs of said computers cluster (8) between said different electricity sources by promoting the cheapest of said different electricity sources.

8. Method of managing electricity providing in a computers cluster, according to claim 6, wherein said different electricity sources include at least one renewable electricity source and/or at least one stored electricity source and/or at least a grid.

9. Method of managing electricity providing in a computers cluster, according to claim 8, wherein said electricity price prediction process (3) uses weather forecasting to predict electricity price provided by a renewable electricity source.

10. Method of managing electricity providing in a computers cluster, according to claim 1, wherein:
said process of prediction of workload (4) receives a feedback from said process of scheduling tasks (7),
said process of prediction of workload (4) improves, based on said feedback.

11. Method of managing electricity providing in a computers cluster, according to claim 10, wherein said feedback, to said process of prediction of workload (4), is based on an evaluation of scheduling performances in said computers cluster (8) more than on an evaluation, if any, of workload prediction precision.

12. Method of managing electricity providing in a computers cluster, according to claim 11, wherein said feedback, to said process of prediction of workload (4), updates a cost function of said process of prediction of workload (4) which is based on an evaluation of scheduling performances in said computers cluster (8) more than on an evaluation, if any, of workload prediction precision.

13. Method of managing electricity providing in a computers cluster, according to claim 11, wherein said feedback, to said process of prediction of workload (4), is based on an evaluation of scheduling performances in said computers cluster (8), and not on an evaluation of workload prediction precision.

14. Method of managing electricity providing in a computers cluster, according to claim 1, further comprising:
sensing an actual workload (5) in said computers cluster (8),
and wherein:
said process of scheduling tasks (7) in said computers cluster (8) is also based on said sensed actual workload.

15. Method of managing electricity providing in a computers cluster, according to claim 14, wherein said actual workload evolves over time, not only the number of tasks to be computed evolves over time, but also the computed resources required by said tasks and the deadlines of said tasks evolve over time.

16. Method of managing electricity providing in a computers cluster, according to claim 1, further comprising:
sensing (6) one or more actual electricity price(s), and wherein:
said process of scheduling tasks (7) in said computers cluster (8) is also based on said sensed actual electricity price(s).

17. Method of managing electricity providing in a computers cluster, according to claim 1, wherein at least one of said prediction processes (3, 4) is based on using support vector machines.

18. Method of managing electricity providing in a computers cluster, according to claim 1, wherein at least one of said prediction processes (3, 4) is based either on using a supervised learning algorithm, or on using a deep learning algorithm.

19. Method of managing electricity providing in a computers cluster, according to claim 1, wherein said process of scheduling tasks (7) is based on using a greedy algorithm.

20. Method of managing electricity providing in a computers cluster, according to claim 1, wherein said process of scheduling tasks (7) is based on using an integer programming algorithm.

21. Method of managing electricity providing in a computers cluster, according to claim 1, wherein said process of scheduling tasks (7) takes into account a constraint of overall electrical power limit.

22. Method of managing electricity providing in a computers cluster, according to claim 1, wherein said process of scheduling tasks (7) takes into account an objective of reducing the platforms overall electricity cost while, at the same time, maintaining high computers cluster (8) utilization.
